(19) United States
(12) Patent Application Publication
(10) Pub. No.: US 2015/0021865 A1
(43) Pub. Date: Jan. 22, 2015

(54) SELF-RIGHTING MEANS FOR LEANING VEHICLES; PRIMARILY BY GRAVITY

(71) Applicant: James Lin, Scarsdale, NY (US)

(72) Inventor: James Lin, Scarsdale, NY (US)

(21) Appl. No.: 13/947,023

(22) Filed: Jul. 20, 2013

(51) Int. Cl. B60G 21/00

(52) U.S. Cl. CPC B60G 21/005
USPC 280/5.513

(57) ABSTRACT

A low cost leaning vehicle stability and self-righting system that primarily uses gravity to return a leaning vehicle position to its original stable upright position. The system accomplishes this by increasing the leaning vehicle's Center of Gravity (CG) above the resting upright position—thus increasing the CG energy state—the more the vehicle leans. The system stores energy—a combination of additional and recovered energy normally lost when the vehicle leans—primarily in the form of gravitational potential energy to automatically return the vehicle from a leaning position to the upright stable position.

### CROSS-REFERENCE TO RELATED APPLICATIONS

This application claims the benefit of provisional application Ser. No. 61/674,341 filed on Jun. 21, 2012.

### BACKGROUND

1. Prior Art

The following is a tabulation of some prior art that presently appears relevant:

U.S. Patents

| Patent Number | Kind Code | Issue Date | Patentee |
|---|---|---|---|
| 2152938 | | 1939 April 4 | Welch |
| 2353503 | | 1944 July 11 | Rost |
| 2743941 | | 1956 May 1 | Walker |
| 3285623 | | 1956 November 15 | Winsen |
| 3601213 | | 1971 August 24 | Patin |
| 3746118 | | 1973 July 17 | Altorfer |
| 4020914 | | 1977 May 3 | Trautwein |
| 4065144 | | 1977 December 27 | Winchell |
| 4072325 | | 1978 February 7 | Bright |
| 4345661 | | 1982 August 24 | Nishikawa |
| 4351410 | | 1982 September 28 | Townsend |
| 4469344 | | 1984 September 4 | Coil |
| 4487429 | | 1984 December 11 | Ruggles |
| 4624469 | | 1986 November 25 | Bourne, Jr. |
| 4632413 | | 1986 December 30 | Fujita |
| 4660853 | | 1987 April 28 | Jephcott |
| 4903857 | | 1990 February 27 | Klopfenstein |
| 5116069 | | 1992 May 26 | Miller |
| 5611555 | | 1997 March 18 | Vidal |
| 5762351 | | 1998 June 9 | SooHoo |
| 5765846 | | 1998 June 16 | Braun |
| 6328125 | B1 | 2001 December 11 | Van Den Brink |
| 6402174 | B1 | 2002 June 11 | Maurer |
| 6554293 | B1 | 2003 April 29 | Fennel |
| 7131650 | B2 | 2006 November 7 | Melcher |
| 7343997 | B1 | 2008 March 18 | Matthies |
| 7438296 | B2 | 2008 October 21 | Stevens |
| 7530419 | B2 | 2009 May 12 | Brudeli |
| 7568541 | B2 | 2009 August 4 | Pfeil |
| 7641207 | B2 | 2010 January 5 | Yang |
| 7665749 | B2 | 2010 February 23 | Wilcox |
| 7887070 | B2 | 2011 February 15 | Kirchner |
| 7946596 | B2 | 2011 May 24 | Hsu |
| 8070172 | B1 | 2011 December 6 | Smith |
| 8123240 | B2 | 2012 February 28 | Mercier |
| 8141890 | B2 | 2012 March 27 | Hughes |

2. Background of the Invention

The present invention relates to vehicles with lean stabilization systems. In particular, the present invention relates to leaning vehicles with the ability to automatically right themselves.

Leaning vehicles—and in particular enclosed “cabin” motorcycles—achieve dynamic stability by leaning into turns to compensate for their narrow profile's relative instability. However, static—low speed and stopped—stability suffers because the dynamic forces that normally keeps the narrow-bodied leaning vehicles from falling over gradually disappear as the vehicle slows down and when stopped—eventually disappear altogether.

This is especially problematic with the enclosed leaning (cabin) motorcycle class of leaning vehicles. The cabin motorcycle marries the efficiency of a motorcycle (light weight and small aerodynamic frontal area) and the weather/crash protection of a car with an enclosed body. Such a vehicle has the potential of replacing many vehicle types—especially in utility motorcycle applications—where their inherent efficiency is retained while the closed body's enhanced weather/crash protection meets long overdue safety and all-weather performance needs (i.e.—Police, utility motorcycle applications).

However, while the cabin motorcycle's enclosed body confers many operating advantages, it also—unlike an open bicycle or motorcycle—deprives the rider of the use of his legs as a readily available and cheap stability aid. Instead, much of the current state of the art leaning vehicle stability systems is devoted to keeping the leaning vehicle upright in this low-speed/static operating regime. Typically such systems use electronic sensor laden computerized hydraulics, servomotors and/or gyroscopes to automatically deploy mechanical substitutes for the rider's legs and prevent the leaning vehicle from falling over. Obviously, such exotic technology is complex and expensive. In fact, they are so expensive as to negate any economic advantages the cabin motorcycles may theoretically have in their potential vehicle markets (i.e.—Police patrol).

For the most part, the present state of the art utilizes various powered systems (hydraulic, electrical, others) to stabilize the leaning vehicle. Of note, U.S. Pat. No. 7,530,419—as a side benefit of its basic layout—utilizes gravity to lessen the effort to right the vehicle from a leaning position. Also U.S. Pat. No. 7,568,541 utilizes an energy (hydraulic) storage system to store some energy into an auxiliary lean control system to assist in righting the leaned vehicle.

Therefore, it is the aim of the present invention to develop a low-cost leaning vehicle stability system—utilizing gravity as the primary driver—to greatly reduce the cost of leaning vehicles. As a result, reduced cost enclosed cabin motorcycles will finally be able find their “natural” market for widespread adoption.

### SUMMARY OF THE INVENTION

Typically, when a vehicle leans, its Center of Gravity (CG) falls and reduces that vehicle's energy state. At this lower energy state, a leaning vehicle cannot return to the original upright position—a higher energy state—unaided. Predictably, the result of the leaning vehicle at this lower energy state is to fall even further to the lowest possible energy state—the ground. Therefore, a preferred embodiment of the present invention is a vehicle with a segmented (multi-part) body structure that's designed to raise the vehicle CG—and energy state—to a higher level with increasing vehicle lean angle. As a result, the vehicle will always return to the original stable upright position because it is always moving from the higher energy state to a lower one.

The present invention uses gravity (primarily—other means are possible) to return the leaning vehicle to an upright resting position in two Steps.

In Step #1, the present invention recovers the potential energy normally lost when the vehicle leans and lifts the vehicle by the equivalent amount. As a result, there is a zero net energy loss when the vehicle leans.

Then in Step #2, a small amount of energy is added to create a “gravity well path”—a net potential energy—to allow the preferred embodiment to automatically return to an upright position.

In Step #1, the preferred embodiment's CG, as with all leaning vehicles, will fall lower the greater the lean angle. Normally, this loss in CG height translates into lost potential energy. However, here the preferred embodiment's segmented body is configured (mechanically, hydraulically, electrically, etc.) to raise the CG up—by bending upward simultaneously—utilizing directly the potential energy expended when the vehicle leans. As a result, there is no loss in the CG energy state because the downward motion of the leaning vehicle's CG has been completely negated by the upward motion of the preferred embodiment's bending. This results in zero net CG movement. (the CG staying level on the vertical “Z” axis).

At this “zero energy-loss” state, the segmented vehicle will be stable in whatever lean angle since it will raise its CG exactly the amount lost during leaning (thus not moving vertically no matter the lean angle). While such a state will prevent the vehicle from falling to the ground, it will also not allow a return the upright position.

Therefore, in Step #2, to allow for an automatic return from a leaning to the upright position, it is necessary to add a small amount of potential energy to make certain the energy state is at a higher level for a greater lean angle and lowest at the upright rest position. As a result, with the higher energy state at the high lean angle and the lowest energy state at the upright position, a “gravity well path” is created where the vehicle CG will always travel “down” from the higher lean angle (higher energy state) to the upright position (lowest energy state).

The relationship between the vehicle lean angle and the upward movement of the segmented vehicle body can be fixed via mechanical (cam), hydraulic, mechanical leverage, dynamic (gyroscopic) or other known means. The relationship between lean angle and raised CG height is set independently to create the desired “slope” of the gravity well path—from very little to a very steep one—depending on how “responsive” the desired automatic upright return.

Additionally, conservation of energy dictates that energy must be inputted into the system to set up a high energy state at high lean angle. Such energy input can be human powered (i.e.—via foot pedals), electrical, pneumatic, hydraulic or other.

### BRIEF DESCRIPTION OF THE DRAWINGS

FIG. 1—Side view comparison between the preferred embodiment segmented vehicle upright position (top) and the leaned position (bottom).

FIG. 2—Front view comparison between the preferred embodiment segmented vehicle upright position (top) and the leaned position (bottom).

FIG. 3—Comparison of the Center of Gravity (CG) side locations between a typical motorcycle and the preferred embodiment's segmented vehicle.

FIG. 4—Dynamic forces relationships acting on a leaning vehicle—here from a typical motorcycle's front view.

FIG. 5—Dynamic forces relationships acting on a leaning vehicle—here the preferred embodiment's segmented vehicle's front.

FIG. 6—Dynamic forces relationships acting on a leaning vehicle—line diagram only.

FIG. 7—Raising the vehicle CG exactly to compensate for the leaning vehicle lowering its CG due to leaning—zero net energy state.

FIG. 8—Raising the vehicle CG to create a “gravity well path”—the higher energy state—at a lean angle to allow an automatic return from a leaning position (and higher energy state) to the upright position (lowest energy state).

FIG. 9—Raising the vehicle CG to create a “gravity well path”—here on the preferred embodiment's segmented vehicle at a lean angle.

FIG. 10—Comparison of the CG locations between the preferred embodiment segmented vehicle upright position (top) and the leaned position (bottom).

### DETAILED DESCRIPTION OF THE PREFERRED EMBODIMENTS

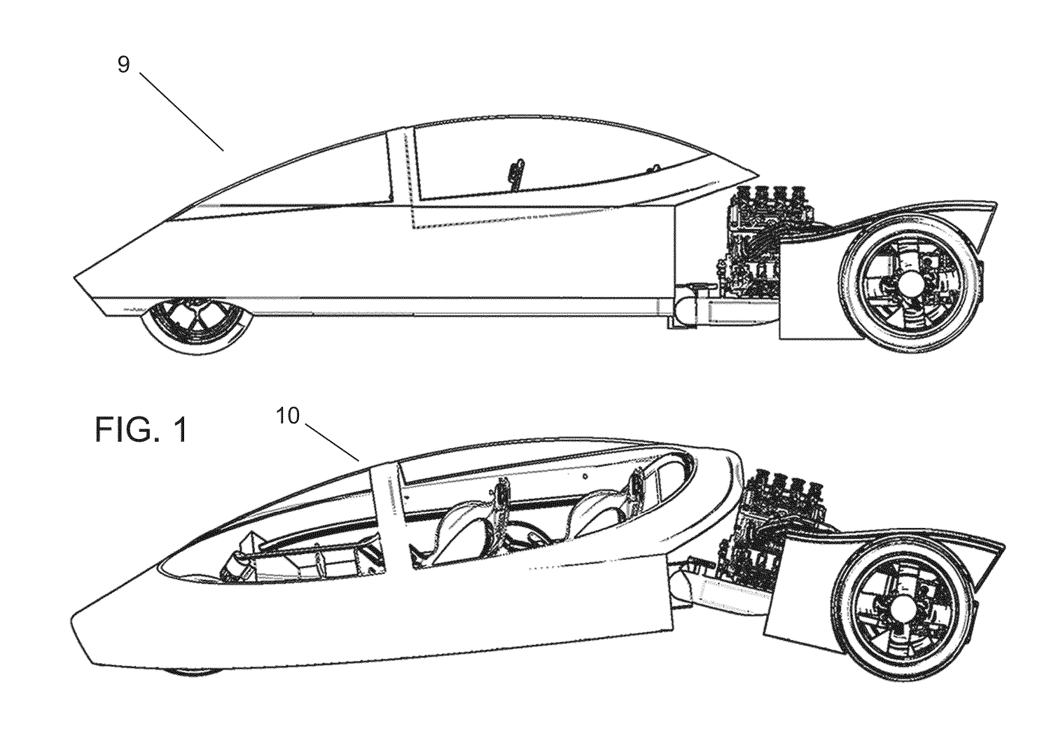

FIG. 1 shows the side views of the upright segmented vehicle 9 (top) and the leaning segment vehicle 10 (bottom) to illustrate how the segmented vehicle bends to raise its CG in the two configurations for this preferred embodiment.

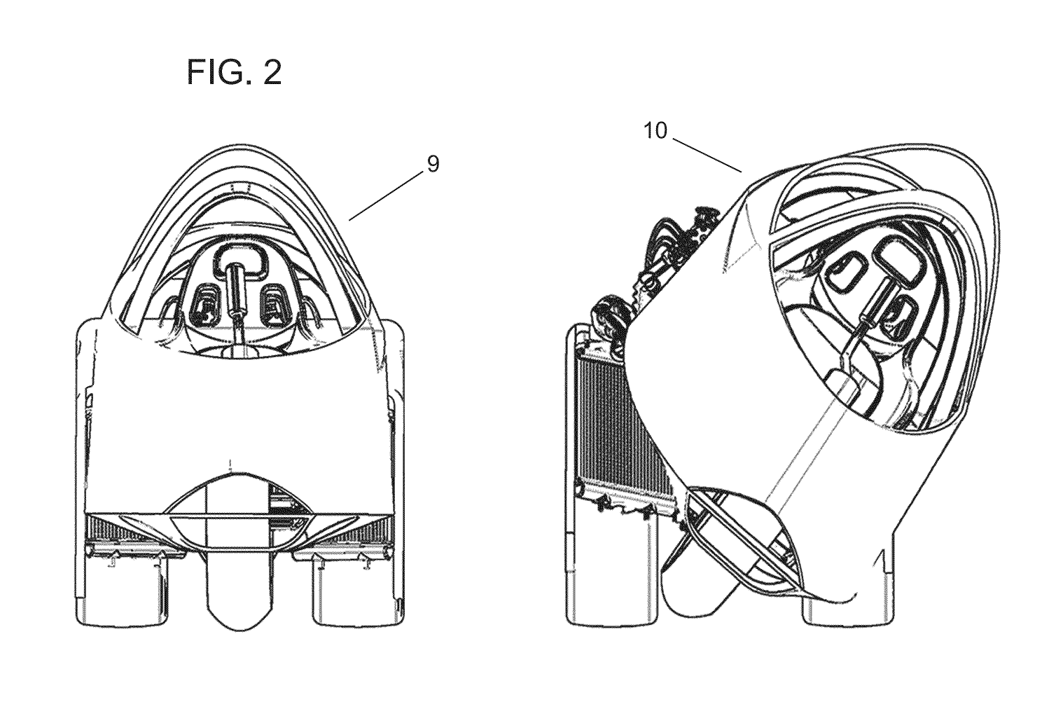

FIG. 2 shows the front views of the upright segmented vehicle 9 (left) and the leaning segment vehicle 10 (right) to illustrate how the segmented vehicle bends in the two configurations.

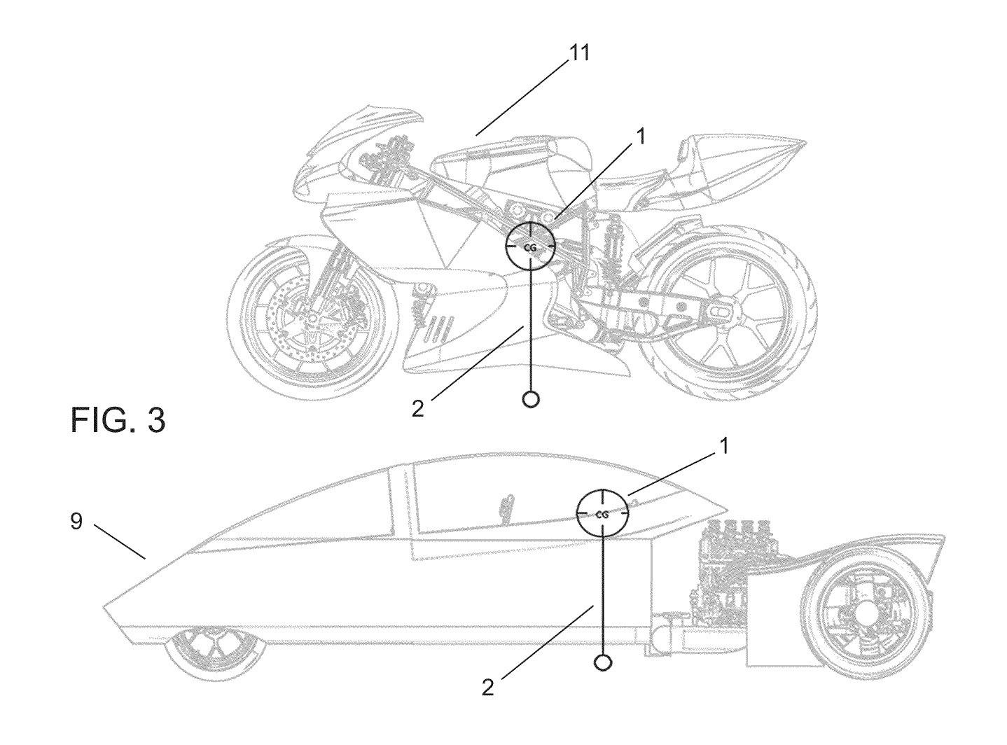

FIG. 3 is a comparison of the typical motorcycle 11's Center of Gravity (CG) CG 1 location versus the preferred embodiment's segmented vehicle 9's CG 1. For each vehicle, the CG 1 is the concentration of mass acting on the moment arm 2 whose fulcrum is in line with the wheels' contact line.

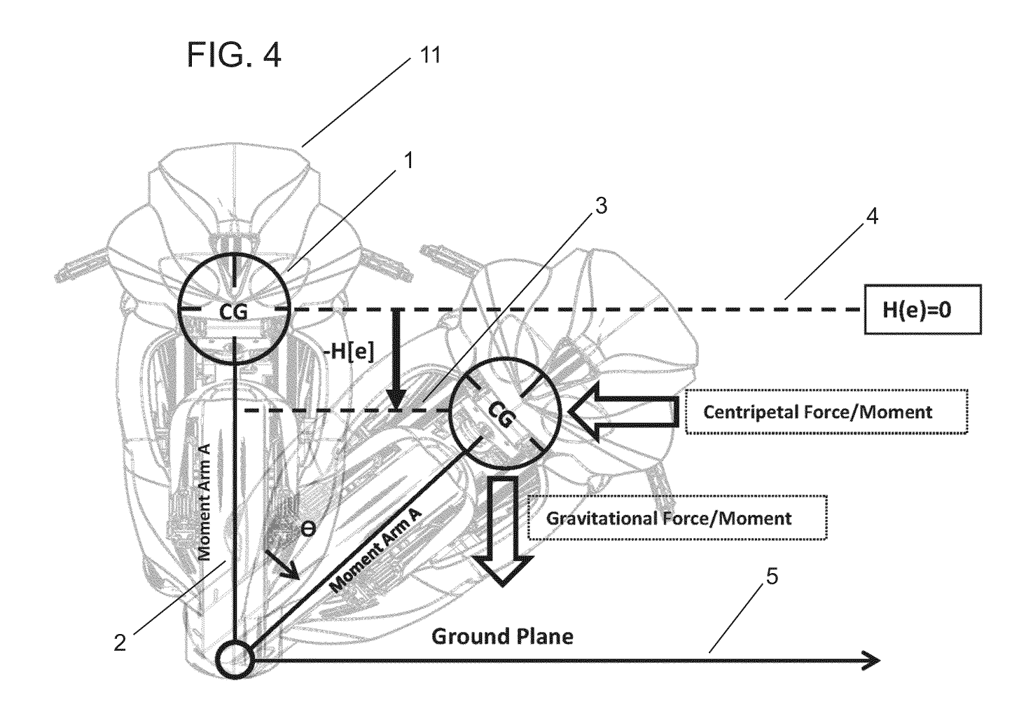

FIG. 4 shows the basic dynamic forces involved with the leaning vehicle—here the typical motorcycle 11.

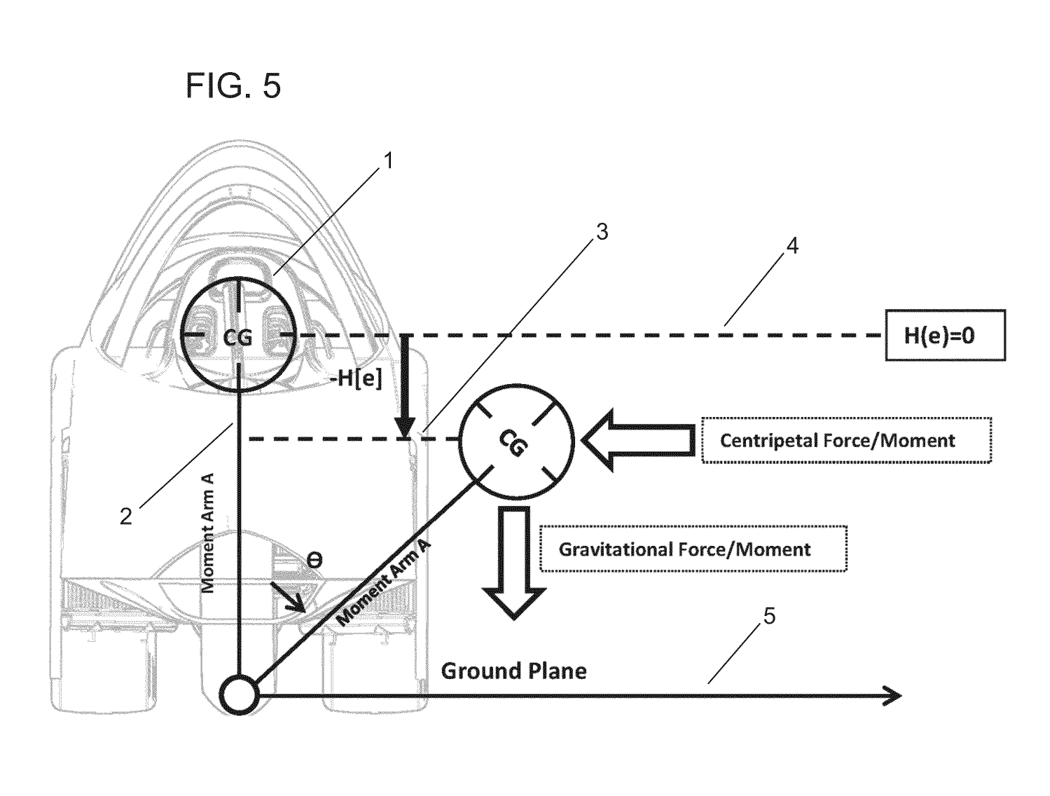

FIG. 5 shows the same forces acting on the segmented vehicle 9.

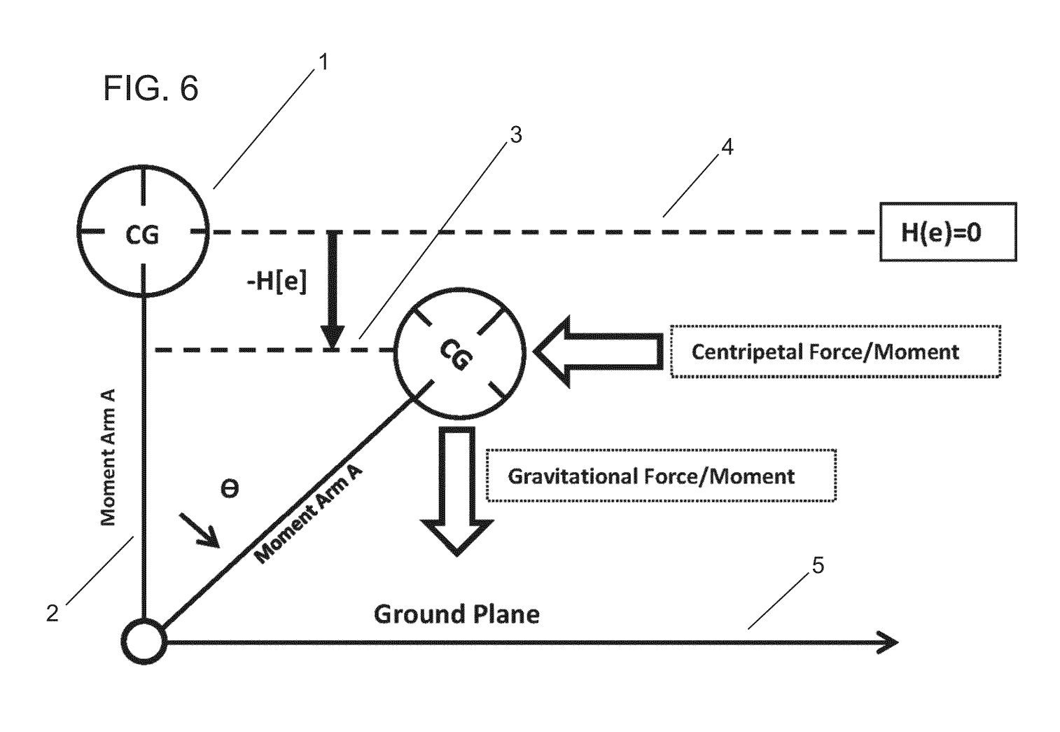

Finally, for clarity, FIG. 6 illustrates only the leaning vehicle forces involved (line diagram only).

For FIG. 4-6, the CG 1 is balanced by the dynamic centripetal force and gravity force through moment arm 2.

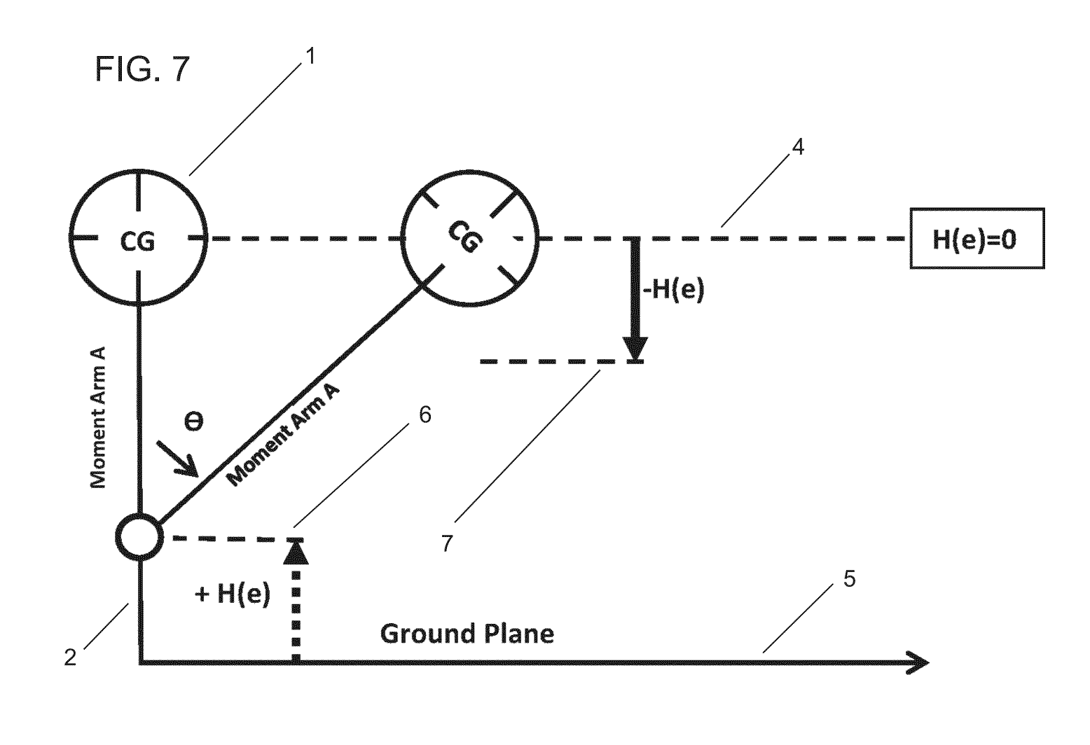

FIG. 7 shows normal downward movement of CG 1—and loss of potential energy −H(e)—being negated by an equal upward movement—and +H(e)—acting through the fulcrum point of moment arm 2 via an input in potential energy +H(e).

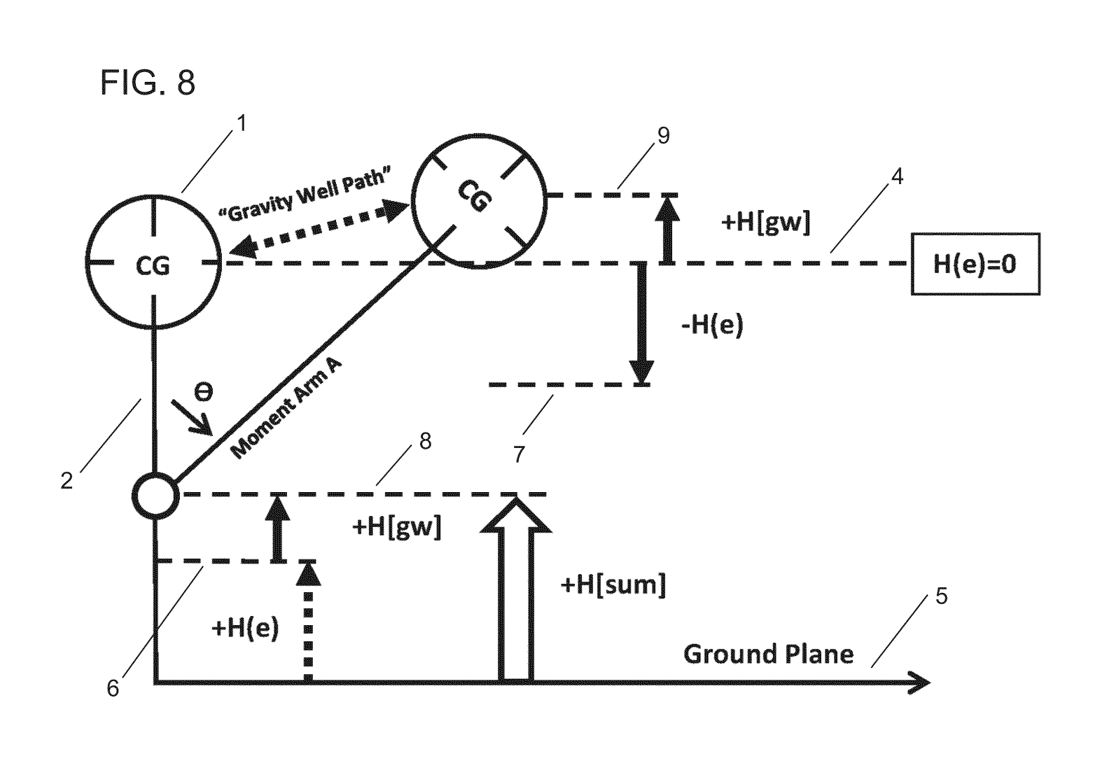

FIG. 8 shows an additional energy input H[gw] that increases to a maximum at maximum vehicle lean angle. H[gw] energy input creates the “gravity well path” for the leaning vehicle to return to the stable upright position.

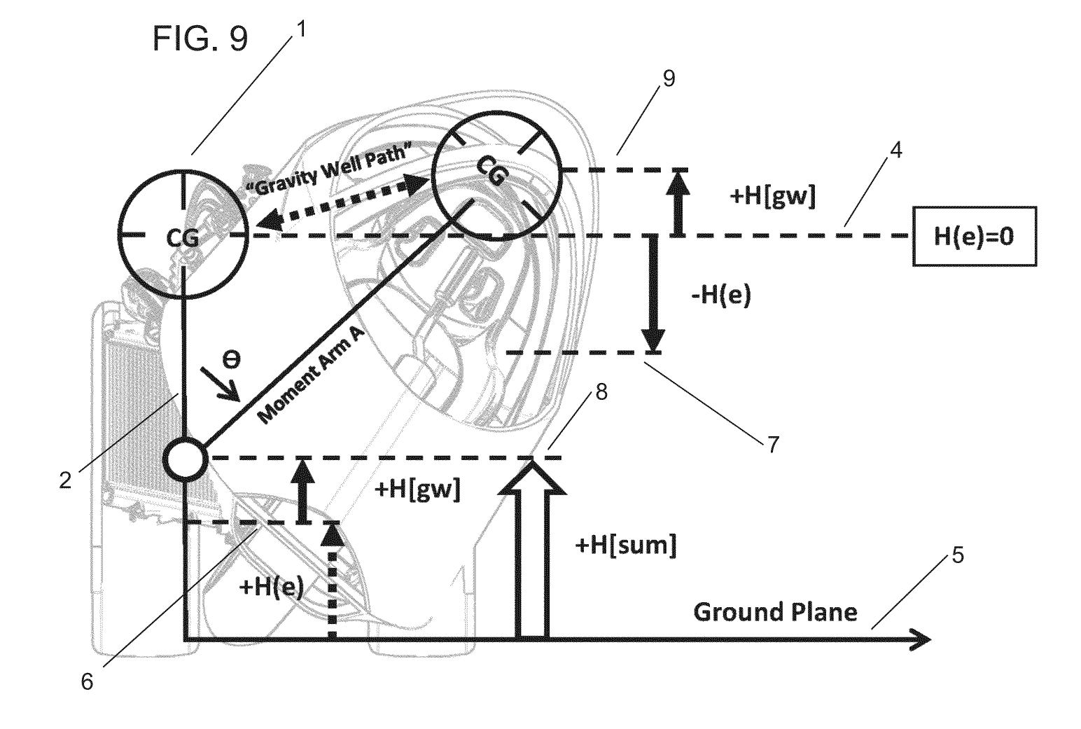

FIG. 9 shows the same force diagram as FIG. 8 but overlaid to the front view of the segmented vehicle to show the relationship between the forces and the vehicle.

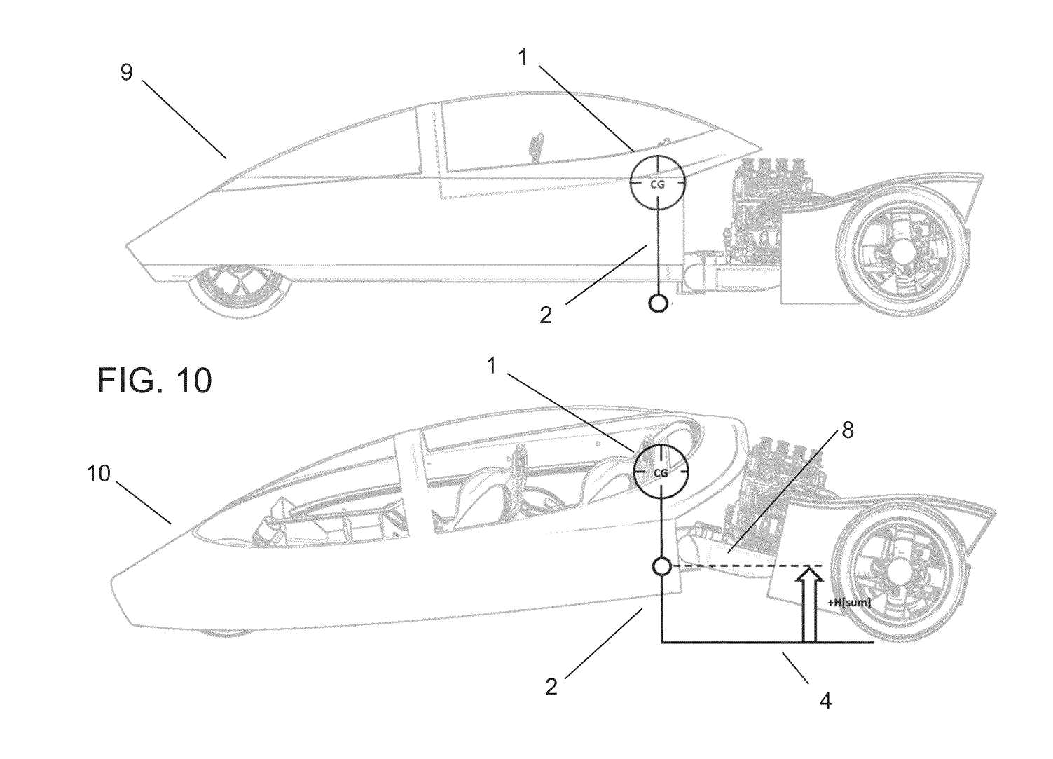

FIG. 10 shows how the leaning segmented vehicle 10 (bottom) bending upwards increases CG 1 potential energy level by +H[sum] from static energy level 4 to leaning energy level 8. In comparison, note that the CG 1 on the upright segmented vehicle 9 (top) at static energy level 4 is less than the CG 1 on the segmented vehicle 10 (bottom) by an energy amount +H[sum].

FIG. 1 shows the side views of the segmented vehicle in the upright rest position 9 (top) and the fully leaned maximum energy position 10 (bottom) as examples of the preferred embodiment.

FIG. 2 shows the frontal views of the upright rest position 9 (left) and the fully leaned maximum energy position 10 (right) for illustration purposes.

FIG. 3 compares the CG 1 location between a typical motorcycle and the preferred embodiment.

FIG. 4-6 illustrates the forces at work for conventional leaning vehicles. Here, for a given lean angle θ the CG moment arm 2 rotates on its fulcrum (in line with the vehicles' road wheels), the vehicles' CG 1 is balanced by two forces acting perpendicular to each other. One is gravity—pulling CG 1 downwards. The other is the centripetal force generated only by a moving and turning vehicle—pulling CG 1 sideways away from the center of the turn.

CG 1 is upright at the reference energy state level 4—as indicated by H(e)=0. For a given lean angle θ, CG 1 drops to the lean angle energy state level 3—a decrease in CG potential energy −H(e). Thus, normally when vehicle speed—and hence centripetal force—is reduced, CG 1 cannot return to the original upright position unaided since lean angle energy state level 3 is less then reference energy state level 4—due to the decreased CG potential energy −H(e). In fact, without dynamic centripetal force supporting CG 1, gravity will cause the CG 1 to fall to the lowest energy state—the ground plane 5.

FIG. 7 illustrates how CG 1 is raised to compensate for the falling CG 1 due to leaning. Here, it shows that, at a lean angle e, CG 1 drops from energy state 4 to energy state 3 by the −H(e) amount. However, instead of allowing CG 1 to fall from reference energy level 4 to a lower energy state 3, the present invention simultaneously raises the moment arm 2's fulcrum by +H(e)—an equal and opposing amount of energy inputted to fully offset the energy loss from leaning. As a result, CG 1's energy level remains at reference energy level 4—regardless of lean angle θ. Therefore, CG 1 will not topple over but remain at reference energy level 4—regardless of the moment arm 2's lean angle θ.

FIG. 7 also shows that, while CG 1 will not topple over, it also will not return to the upright position. In fact, as configured, it is stable no matter the lean angle since CG 1 will always remain at the static upright level 4. This is a detailed description of the “Step #1” described earlier.

In FIG. 8, an additional energy input H[gw]—for a given lean angle θ—lifts CG 1 above reference energy level 4 to energy level 8. As a result, a “gravity well path” is created between leaning angle energy level 8—at lean angle θ—and reference energy level 4—the full upright position at lean angle θ=0. Since leaning angle energy level 8 is always greater than reference energy 4, at any lean angle θ, CG 1 will always return to the full upright reference energy level 4 position automatically since this is now the lowest energy level. This is a more detailed explanation of the “Step 2” procedure described earlier.

FIG. 8 shows that the total energy input +H[sum] is the sum of two components −H(e)—lean angle energy loss and H[gw]—gravity well path:

H(sum)=H(e)+H(gw)−H(e)[leaning energy loss]

H[sum] represents the total energy input into the present invention to create the gravity well path from the lean angle θ to the static upright state. However, note that since H(e) leaning vehicle energy input is cancelled out exactly by the leaning vehicle itself, H(sum) is actually only the net input energy H[gw].

FIG. 9 overlays the forces illustrated in FIG. 6 to the preferred segmented vehicle embodiment front view to illustrate the location relationships of the forces to the vehicle. The segmented vehicle is bending upward while at leaning angle e in order to input H(sum)—the energy required to create the “gravity well path” and automatically return the vehicle to the full upright position from any lean angle.

FIG. 10 shows the segmented vehicle in the upright rest position 9 (top) and the fully leaned maximum energy position 10. Note the segmented vehicle bending in the middle to raise CG 1 by the H[sum] energy amount—from reference energy level 4 to maximum lean energy level 7.

### Alternative Embodiments

While the preferred embodiment lifts the CG via a 2-piece segmented vehicle structure, other known means of raising the CG with increasing lean angle is possible. Some possible alternative embodiments use levered suspensions, hydraulic jacking, counterweights and other means. Whatever the embodiment, so long as it follows the present inventions rules of operation to raise the CG independently to compensate for CG drop due to lean angle, it will function correctly.

### CONCLUSIONS, RAMIFICATIONS AND SCOPE

Accordingly it is clear the many advantages of utilizing gravity—a readily available energy source—to stabilize the leaning vehicle. First, it is readily simple to utilize—with the simplest method using a cam to lift the vehicle CG upward in direct relationship to lean angle in the present embodiment. Second, it is also mechanically simple as the cam-driven present embodiment also illustrates. Finally, since the present invention sets the resting upright position to be the lowest energy state, no matter the lean angle position of the preferred embodiment, powered or not, the vehicle will always return to the upright position.

All this confers to this invention the advantages of security, safety and low cost—perfect attributes for this stability system.

I claim:

1. A vehicle lean stabilization system comprising:
a. Means to separately control the lean angle of said vehicle's center of gravity as defined by a moment arm from said vehicle's center of gravity to said vehicle's surface reference plane and the vertical plane.
b. Means to separately control said vehicle's center of gravity's vertical energy state.
c. Means to link said center of gravity lean angle control to said center of gravity vertical energy control wherein an increase in said vehicle's center of gravity lean angle from the vertical plane is accompanied by a corresponding increase in said vehicle's center of gravity vertical energy state.
d. Means to offset a normal drop in said vehicle center of gravity vertical energy when leaning with an equivalent increase in vehicle center of gravity vertical energy resulting in zero net center of gravity energy change.
e. Means to define said vehicle lean stability system whereby said vehicle's center of gravity is at a minimum energy state at zero lean angle and a maximum energy state at maximum lean angle.
f. Means to add energy into said vehicle lean stability system to transform said vehicle center of gravity from a zero lean angle/minimum energy level state to a maximum lean angle/maximum energy level state.
g. Means to release energy from said vehicle lean stability system to transform said vehicle center of gravity from said maximum lean angle/maximum energy state to said zero lean angle/minimum energy state.

2. The vehicle lean stabilization system of claim 1 wherein:
a. Means to separately control the lean angle of said vehicle's center of gravity as defined by a moment arm from said vehicle's center of gravity to said vehicle's ground reference plane and the vertical plane.
b. Means to separately control said vehicle's center of gravity's vertical height.
c. Means to link said center of gravity lean angle control to said center of gravity height control wherein an increase in said vehicle's center of gravity lean angle from the vertical plane is accompanied by a corresponding increase in said vehicle's center of gravity height.
d. Means to offset a normal drop in said vehicle center of gravity height when leaning with an equivalent increase in vehicle center of gravity height resulting in zero net center of gravity height change.
e. Means to define said vehicle lean stability system whereby said vehicle's center of gravity is at a minimum height at zero lean angle and a maximum height at maximum lean angle.
f. Means to add energy into said vehicle lean stability system to transform said vehicle center of gravity from a zero lean angle/minimum height state to a maximum lean angle/maximum height state.
g. Means to release energy from said vehicle lean stability system to transform said vehicle center of gravity from said maximum lean angle/maximum height state to said zero lean angle/minimum height state.

3. The vehicle lean stabilization system of claim 2 wherein manual, partially or fully powered systems provide the means to control and add energy to said lean stabilization system.

4. The vehicle lean stabilization system of claim 3 wherein manual, partially or fully powered systems are right and left foot pedals.

5. The vehicle lean stabilization system of claim 2 wherein means to link said center of gravity lean angle control to said center of gravity vertical energy control is via a cam actuation mechanism.

6. The vehicle lean stabilization system of claim 2 wherein control of said vehicle center of gravity lean angle and height is via a segmented, dual-body vehicle layout.

7. The vehicle lean stabilization system of claim 2 wherein said center of gravity lean angle and height is controlled via independent actuation of suspension systems on a single bodied vehicle.

8. The vehicle lean stabilization system of claim 2 wherein said center of gravity lean angle and height is controlled partially or fully by computer.
